(19) United States
(12) Patent Application Publication
(10) Pub. No.: US 2007/0283935 A1
(43) Pub. Date: Dec. 13, 2007

(54) Fuel pump control apparatus for internal combustion engine

(75) Inventors: Shuji Yuda, Gotenba-shi (JP); Masakatsu Nagai, Hiratsuka-shi (JP); Tomohiro Nakano, Susono-shi (JP); Takahiro Uchida, Gotenba-shi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, TOYOTA-SHI (JP)

(21) Appl. No.: 11/798,261

(22) Filed: May 10, 2007

(30) Foreign Application Priority Data
May 16, 2006 (JP) 2006-136227
May 16, 2006 (JP) 2006-136230

(51) Int. Cl. F02M 57/02; F02M 37/04

(52) U.S. Cl. 123/497; 123/446

(57) ABSTRACT

A fuel pump control apparatus for an internal combustion engine includes a plurality of fuel pumps that discharge fuel so that the discharged fuel is supplied to the internal combustion engine; and a controller that determines whether to supply the fuel discharged from one of the plurality of fuel pumps to the internal combustion engine, or to supply all the fuel discharged from the plurality of fuel pumps together to the internal combustion engine, based on the operating condition of the internal combustion engine.

### INCORPORATION BY REFERENCE

The disclosure of Japanese Patent Application No. 2006-136227 filed on May 16, 2006 and No. 2006-136230 filed on May 16, 2006, including the specification, drawings and abstract is incorporated herein by reference in its entirety.

### BACKGROUND OF THE INVENTION

1. Field of the Invention

The invention relates to a fuel pump control apparatus for an internal combustion engine, which controls a plurality of fuel pumps.

2. Description of the Related Art

Japanese Patent Application Publication No. 2002-213326 (JP-A-2002-213326) describes a fuel pump control apparatus that is employed for a V-engine. In the fuel pump control apparatus, paired high-pressure fuel pumps are provided for paired banks. High-pressure fuel is guided from the high-pressure fuel pumps to the respective banks through high-pressure fuel pipes. The high-pressure fuel pipes are connected to each other by a connection pipe. A single control unit supplies the high-pressure fuel to the high-pressure fuel pipes for the banks, while controlling the amounts of fuel discharged from the high-pressure fuel pumps. When the amount of fuel required for the engine is small, one of the high-pressure fuel pumps is stopped, for example, to reduce the operating noise of the pumps. Japanese Patent Application Publication No. 2000-130232 (JP-A-2000-130232) describes a control apparatus that performs fuel injection using the fuel pressure from a feed pump when a malfunction occurs in a high-pressure fuel pump. Based on the amount of fuel injected by the fuel pressure from the feed pump, the control apparatus limits the amount of air taken into the internal combustion engine, or cuts off fuel supply.

If the frequency of operating at least one of the fuel pumps is lower than the frequency of operating the rest of the fuel pumps as in the fuel pump control apparatus described in the Publication No. 2002-213326, the movable portion of the at least one of the fuel pumps, which is operated with lower frequency, is likely to be fixed. As a result, when all the pumps need to be operated, a required amount of fuel may not be supplied.

In the control apparatus described in the Publication No. 2002-213326, because the single control unit controls the fuel discharge operations of the plurality of fuel pumps, there is only one control system for the plurality of fuel pumps. Therefore, for example, when a failure occurs in the control unit and the fuel supply function of the only one control system is lost, the fuel cannot be supplied, and the operation of the internal combustion engine cannot be continued. In the control apparatus described in the publication No. 2000-130232 as well, there is only one control system. Therefore, a similar problem may occur.

### SUMMARY OF THE INVENTION

In view of the above, the invention provides a control apparatus for an internal combustion engine, which continues the operation of an internal combustion engine when a malfunction occurs in a control system for a fuel supply device that includes a plurality of fuel pumps.

A first aspect of the invention relates to a fuel pump control apparatus for an internal combustion engine, which includes a plurality of fuel pumps that discharge fuel so that the discharged fuel is supplied to the internal combustion engine; and a controller that determines whether to supply the fuel discharged from one of the plurality of fuel pumps to the internal combustion engine, or to supply all the fuel discharged from the plurality of fuel pumps together to the internal combustion engine, based on the operating condition of the internal combustion engine.

The controller may include a first pump controller and a second pump controller. In this case, the first pump controller operates each of the plurality of fuel pumps based on the amount of fuel required for the internal combustion engine so that the frequency of operating at least one of the plurality of fuel pumps is lower than the frequency of operating the rest of the plurality of fuel pumps. The second pump controller operates the at least one of the plurality of fuel pumps when a predetermined condition for the first pump controller to stop the at least one of the plurality of fuel pumps is satisfied.

In the above-described fuel pump control apparatus for an internal combustion engine, the first pump controller stops at least one of the fuel pumps, or operates all the fuel pumps, based on the amount of fuel required for the internal combustion engine. Thus, an appropriate amount of fuel is supplied to the internal combustion engine. When a predetermined condition for the first pump controller to stop the at least one of the fuel pumps is satisfied, the second pump controller appropriately operates the at least one of the fuel pumps. This reduces the possibility that the movable portion of the at least one of the fuel pumps, which is operated with lower frequency, is fixed.

In the fuel pump control apparatus for an internal combustion engine, the controller may further include a plurality of control units which are divided into a plurality of control systems, and which control the plurality of fuel pumps that are divided into the plurality of control systems. In this case, each of the plurality of control units includes a malfunction determination device that determines whether a malfunction occurs in the fuel supply function of each of the plurality of control systems excluding a control system to which the malfunction determination device belongs; and a pump operation device that operates at least one of the plurality of fuel pumps, which belongs to the control system to which the pump operation device belongs, to continue the operation of the internal combustion engine, when the malfunction determination device determines that a malfunction occurs in the fuel supply function of at least one of the plurality of control systems.

In the above-described fuel pump control apparatus for an internal combustion engine, the fuel pumps are divided into the plurality of control systems, and the control units are divided into the plurality of control systems. Therefore, when a malfunction occurs in the fuel supply function of at least one of the control systems, at least one control unit that belongs to the rest of the control systems operates at least one fuel pump that belongs to the rest of the control systems. Accordingly, the fuel is supplied to the internal combustion engine. Thus, it is possible to continue the operation of the internal combustion engine, in accordance with the amount of fuel that can be supplied from at least one fuel pump that belongs to at least one control system in which no malfunction occurs.

### BRIEF DESCRIPTION OF THE DRAWINGS

The features, advantages thereof, and technical and industrial significance of this invention will be better understood by reading the following detailed description of example embodiments of the invention, when considered in connection with the accompanying drawings, in which:

FIG. 1 shows an embodiment in which the invention is applied to a control apparatus for a V-engine that is one example of an internal combustion engine;

FIG. 2 is a diagram showing a fuel supply device in FIG. 1 in detail;

FIG. 3 is a flowchart showing a first fuel pump control routine, which is executed by an ECU for a right bank;

FIG. 4 is a flowchart showing a second fuel pump control routine, which is executed by an ECU for a left bank;

FIG. 5 is a flowchart showing a fail-safe control routine, which is executed by each ECU; and

FIG. 6 is a flowchart showing a high-temperature start control routine, which is executed by each ECU.

### DETAILED DESCRIPTION OF THE EXAMPLE EMBODIMENTS

In the following description and the accompanying drawings, the present invention will be described in more detail with reference to example embodiments.

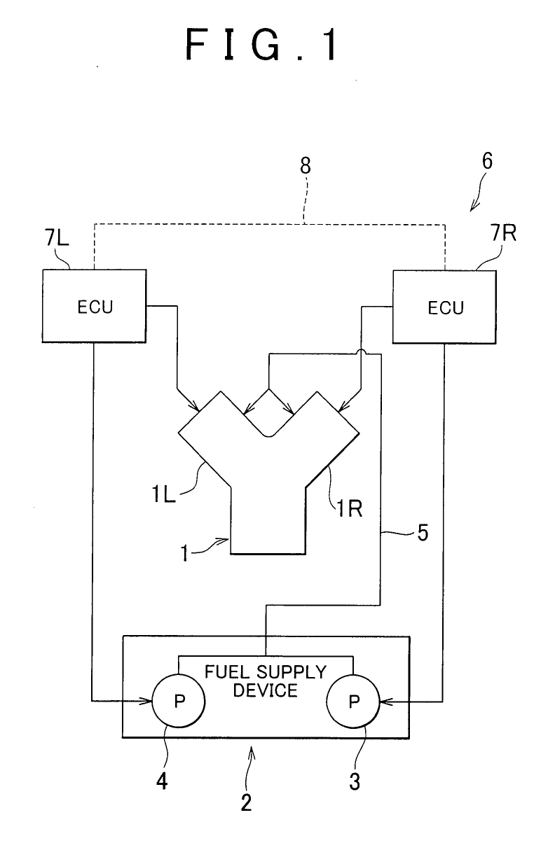

FIG. 1 shows the case in which a fuel pump control apparatus according to an embodiment of the invention is employed for a V-engine (hereinafter, will be sometimes simply referred to as “engine”), which is an example of an internal combustion engine. The engine 1 is provided in a vehicle, and functions as a power source for driving the vehicle. The engine 1 includes paired right and left banks 1R and 1L. In each of the banks 1R and 1L, an appropriate number of cylinders (not shown) are provided. The engine 1 is provided with a fuel supply device 2 and a control device 6. The fuel supply device 2 includes a first fuel pump 3 and a second fuel pump 4. Fuel discharged from the fuel pump 3 and fuel discharged from the fuel pump 4 flow together into a common fuel supply passage 5. Then, the fuel is distributed from the fuel supply passage 5 to respective high-pressure fuel pipes (not shown) for the banks 1R and 1L. The high-pressure fuel stored in the high-pressure pipes is injected into the cylinders from respective fuel injection valves (not shown) provided in the cylinders. The configuration of a portion between the high-pressure pipes and the fuel injection valves is the same as in a known internal combustion engine.

The control device 6 includes paired engine control units (hereinafter, referred to as ECUs) 7R and 7L. The ECUs 7R and 7L are computer units that control the operating condition of the engine 1 according to predetermined control programs. The ECU 7R controls the right bank 1R, and the ECU 7L controls the left bank 1L. That is, in this embodiment, the ECU 7R controls the operating condition of the bank 1R of the engine 1, and the ECU 7L controls the operating condition of the bank 1L of the engine 1. The ECUs 7R and 7L are connected to each other via a communication line 8. Various pieces of information required for controls are transmitted between the ECUs 7R and 7L via the communication line 8.

The ECUs 7R and 7L also control the first fuel pump 3 and the second fuel pump 4, respectively. In this embodiment, the ECU 7R for the right bank 1R controls the operation of the first fuel pump 3. The ECU 7L for the left bank 1L controls the operation of the second fuel pump 4. That is, the ECU 7R may function as the first control unit, and the ECU 7L may function as the second control unit. The first fuel pump 3 and the ECU 7R constitute a control system. The second fuel pump 4 and the ECU 7L constitute another control system. In other words, the first and second fuel pumps 3 and 4 are divided into two control systems (i.e., the first and second fuel pumps 3 and 4 belong to respective control systems) so that the ECUs 7R and 7L control the first fuel pump 3 and second fuel pump 4, respectively.

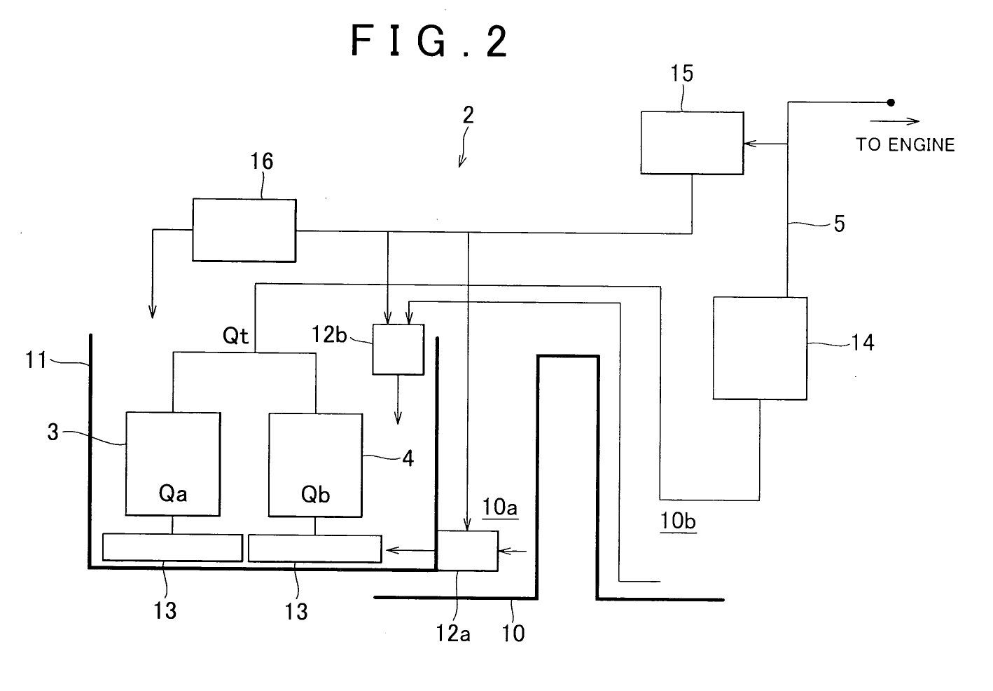

FIG. 2 shows the fuel supply device 2 in detail. The fuel supply device 2 includes a fuel tank 10. The inner portion of the fuel tank 10 is divided into a first chamber 10a and a second chamber 10b. In the first chamber 10a, a sub-tank 11 is provided. The first and second fuel pumps 3 and 4 are provided inside the sub-tank 11. In the sub-tank 11, a first jet pump 12a and a second jet pump 12b are provided. The first jet pump 12a sucks the fuel stored in the first chamber 10a, and discharges the fuel into the sub-tank 11. The second jet pump 12b sucks the fuel stored in the second chamber 10b, and discharges the fuel into the sub-tank 11. Suction filters 13 are connected to the suction sides of the first and second fuel pumps 3 and 4. Each suction filter 13 filters the fuel in the sub-tank 11. As described above, the discharge sides of the first and second fuel pumps 3 and 4 are connected to the common fuel supply passage 5. A fuel filter 14 is provided in the fuel supply passage 5. The downstream side (that is, the engine 1-side) of the fuel filter 14 is connected to a pressure regulator 15. The pressure regulator 15 regulates the pressure of fuel to be delivered to the engine 1, to a predetermined pressure. The surplus fuel discharged from the pressure regulator 15 is returned to the sub-tank 11 via the second jet pump 12b. The discharge side of the pressure regulator 15 is connected to a relief valve 16. The fuel discharged from the relief valve 16 is also returned to the sub-tank 11.

The fuel discharge capacities of the first and second fuel pumps 3 and 4 may be appropriately determined, as long as the total amount Qt of maximum discharge amounts Qa and Qb is larger than the maximum value of a required fuel amount. The maximum discharge amounts Qa and Qb are the maximum amounts of fuel that can be discharged from the first and second fuel pumps 3 and 4, respectively, per unit time. The required fuel amount is the amount of fuel required to operate the engine 1 in a target operating condition, per unit time. The maximum discharge amounts Qa and Qb may be equal to each other. However, in this embodiment, the maximum discharge amount Qa of the first fuel pump 3 is larger than the maximum discharge amount Qb of the second fuel pump 4. A variable resistor is provided in a circuit (not shown) for driving the first fuel pump 3. By operating the variable resistor, the voltage for driving the first fuel pump 3 is changed. Thus, the amount of fuel discharged from the first fuel pump 3 (hereinafter, will be sometimes referred to as “fuel discharge amount of the first fuel pump 3”) may be switched between two levels, i.e., a small discharge amount and a large discharge amount. The large discharge amount is set to the maximum discharge amount of the first fuel pump 3. The amount of fuel discharged from the second fuel pump 4 (hereinafter, will be sometimes referred to as “fuel discharge amount of the second fuel pump 4”) is set to a constant amount. That is, when the second fuel pump 4 is turned on, a predetermined amount of fuel is discharged from the second fuel pump 4. When the second fuel pump 4 is turned off, the operation of the second fuel pump 4 is stopped. That is, when the operation of each of the first and second fuel pumps 3 and 4 is stopped, the amount of fuel discharged from each of the first and second fuel pumps 3 and 4 is “0”. Taking this into account, the fuel discharge amount of the first fuel pump 3 may be switched among three levels, i.e., the small discharge amount, the large discharge amount, and “0”. The fuel discharge amount of the second fuel pump 4 may be switched between two levels, i.e., the constant discharge amount, and “0”. The maximum discharge amount of the second fuel pump 4 is the fuel discharge amount when the second fuel pump 4 is turned on. The ECUs 7R and 7L switch the fuel discharge amounts of the first and second fuel pumps 3 and 4, respectively, according to a required flow amount of fuel (hereinafter, referred to as “required fuel flow amount”), as described in the following table.

| | Required Fuel Flow Amount | | |
|---|---|---|---|
| | Small Range | Medium Range | Large Range |
| First Fuel Pump | Small Discharge | Large Discharge | Large |
| | Amount | Amount | Discharge |
| | | | Amount |
| Second Fuel Pump | Off | Off | On |

Each of the ECUs 7R and 7L repeatedly calculates, in predetermined time intervals, a fuel injection amount required to operate the engine 1 in the target operating condition. Based on the fuel injection amount, each of the ECUs 7R and 7L calculates the required fuel flow amount. Then, the ECUs 7R and 7L switch the operations of the first and second fuel pumps 3 and 4, respectively, based on which of ranges (a small amount range, a medium amount range, and a large amount range) the required fuel flow amount falls in. The fuel injection amount may be calculated by a known method, i.e., by correcting a basic fuel injection amount in various manners. The basic fuel injection amount is calculated based on an engine speed and an intake air amount (or a parameter that indicates an engine load, such as an accelerator-pedal operation amount). The required fuel flow amount is set to a value obtained by accumulating a fuel injection amount per unit time, or a value larger than the value obtained by accumulating the fuel injection amount per unit time. When the required fuel flow amount is in the small amount range, the ECU 7R operates the first fuel pump 3 so that the fuel discharge amount is equal to the small discharge amount, and the ECU 7L turns the second fuel pump 4 off, i.e., stops the second fuel pump 4. When the required fuel flow amount is in the medium amount range, the ECU 7R operates the first fuel pump 3 so that the fuel discharge amount is equal to the large discharge amount, and the ECU 7L turns the second fuel pump 4 off, i.e., stops the second fuel pump 4. When the required fuel flow amount is in the large amount range, the ECU 7R operates the first fuel pump 3 so that the fuel discharge amount is equal to the large discharge amount, and the ECU 7L turns the second fuel pump 4 on, i.e., operates the second fuel pump 4. This control of the first and second fuel pumps 3 and 4 is referred to as “normal control”. During the normal control, when the required fuel flow amount is in the large amount range, the first fuel pump 3 is operated so that the fuel discharge amount is equal to the large discharge amount, and the second fuel pump 4 is also operated. The fuel discharged from the first fuel pump 3 and the fuel discharged from the second fuel pump 4 join together, and are supplied to the engine 1. Thus, the required amount of fuel is supplied when the engine 1 is operated under a high load. When the load of the engine 1 decreases, and accordingly the required fuel flow amount is in the medium amount range, the second fuel pump 4 is stopped. When the load of the engine 1 further decreases, and accordingly the required fuel flow amount is in the small amount range, the first fuel pump 3 is operated so that the fuel discharge amount is equal to the small discharge amount. This reduces the amount of electric power consumed by the first and second fuel pumps 3 and 4, or reduces operating noise of the first and second fuel pumps 3 and 4. The border value between the large amount range and the medium amount range, and the border value between the medium amount range and the small amount range may be constant, or may appropriately change according to the operating condition of the engine 1. The border value between the large amount range and the medium amount range may be regarded as the predetermined value based on which the second fuel pump 4 is operated or stopped.

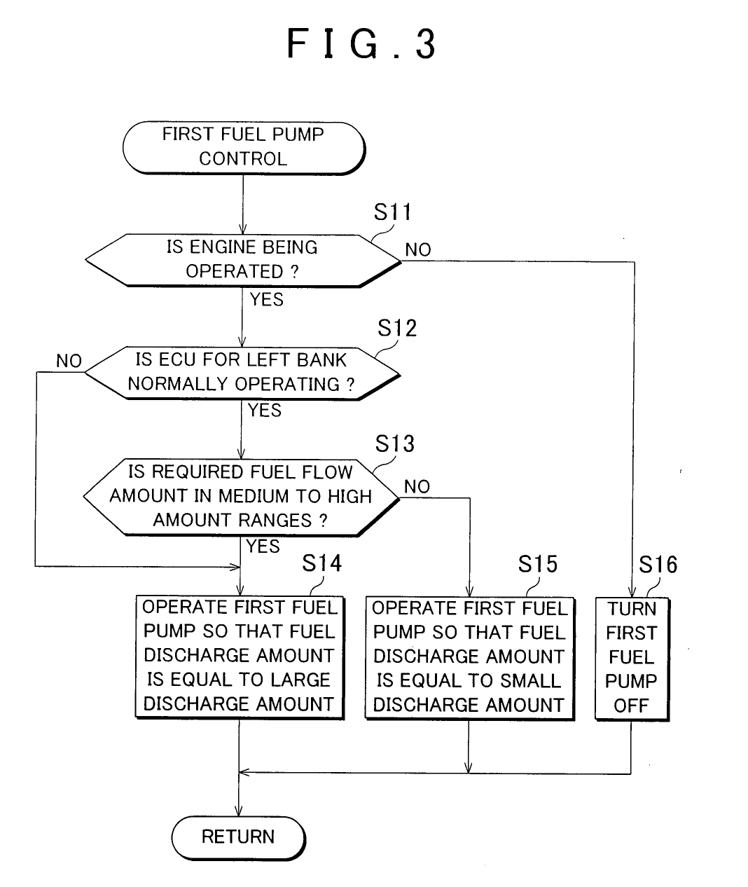

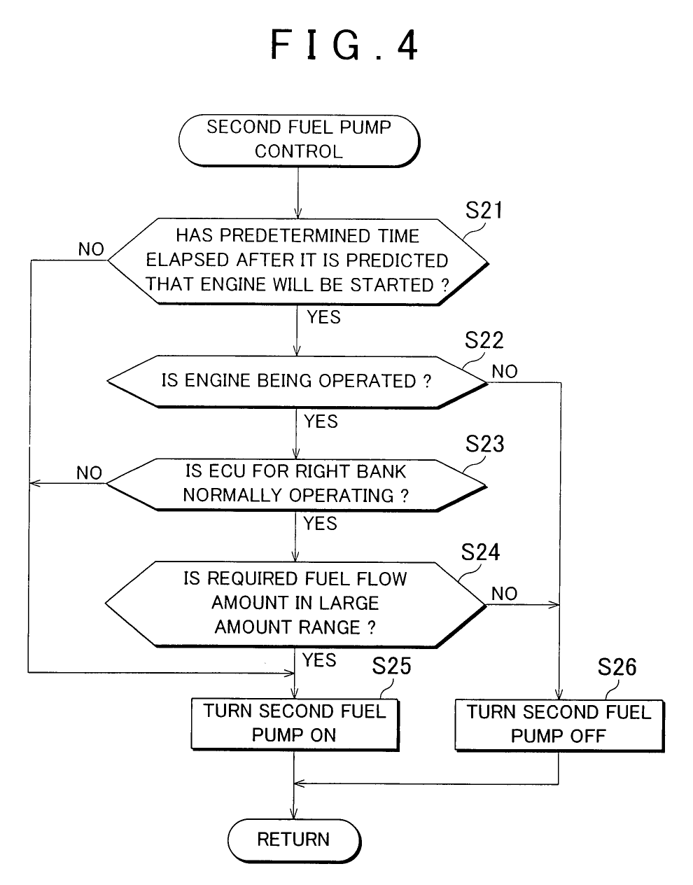

Predetermined control signals are transmitted between the ECU 7R and 7L via the communication line 8. Thus, the ECU 7R monitors whether the ECU 7L normally performs a control function, and the ECU 7L monitors whether the ECU 7R normally performs a control function. When a malfunction occurs in one of the ECUs 7R and 7L, the first and second fuel pumps 3 and 4 are controlled according to a control procedure that differs from the above-described normal control, to continue the operation of the engine 1 in the operating condition that is as closest as possible to the target operating condition. Hereinafter, the control procedure according to which the ECUs 7R and 7L control the first and second fuel pumps 3 and 4 will be described with reference to FIG. 3 and FIG. 4.

FIG. 3 shows a first fuel pump control routine, which is executed by the ECU 7R. The routine is repeatedly executed at predetermined time intervals while electric power is supplied to the ECU 7R and the ECU 7R is operating. In first step S11 of the routine in FIG. 3, the ECU 7R determines whether the engine 1 is being operated. The phrase “the engine 1 is being operated” signifies that the engine 1 is being operated by combustion of fuel. In step S12, the ECU 7R determines whether the ECU 7L for the left bank 1L is normally operating, that is, whether the ECU 7L is normally performing the control function. When it is determined that the ECU 7L is normally operating, the ECU 7R determines whether the required fuel flow amount is in the medium to high amount ranges, or in the small range, in step S13. When it is determined that the required fuel flow amount is in the medium to high amount ranges, the ECU 7R operates the first fuel pump 3 so that the fuel discharge amount is equal to the large discharge amount in step S14. When it is determined that the required fuel flow amount is in the small amount range, the ECU 7R operates the first fuel pump 3 so that the fuel discharge amount is equal to the small discharge amount in step S15. By executing steps S12, S13, and S14 or S15, the above-described normal control of the first fuel pump 3 is executed.

When it is determined that a malfunction occurs in the ECU 7L for the left bank 1L in step S12, the ECU 7R skips step S13, and proceeds to step S14. Thus, when a malfunction occurs in the ECU 7L, the first fuel pump 3 is operated so that the fuel discharge amount is equal to the large discharge amount, regardless of the required fuel flow amount. This control is executed for the following reason. When a malfunction occurs in the ECU 7L, the second fuel pump 4 is unable to supply the fuel. Therefore, by operating the first fuel pump 3 so that the fuel discharge amount is equal to the large discharge amount, it is possible to reduce the possibility that a problem, such as misfire and deterioration of a catalyst, occurs due to shortage of fuel supply. When it is determined that the engine 1 is stopped in step SI 1, the ECU 7R turns the first fuel pump 3 off, i.e., stops the first fuel pump 3 in step S16. After the ECU 7R controls the operation of the first fuel pump 3 in one of steps 14 to 16, the ECU 7R ends the present routine.

FIG. 4 shows a second fuel pump control routine, which is executed by the ECU 7L. This routine is repeatedly executed at predetermined time intervals while electric power is supplied to the ECU 7L and the ECU 7L is operating. In first step S21 of the routine in FIG. 4, the ECU 7L determines whether a predetermined time has elapsed after it is predicted that the engine 1 will be started. When operation relating to start of the engine 1 is detected, for example, when it is determined that an ignition switch is turned on, or when it is determined that an occupant climbs into a driver's seat, it may be determined that it is predicted that the engine 1 will be started. For example, when the door of the driver's seat is opened, or when an occupant sits on the driver's seat, it may be determined that an occupant climbs into the driver's seat. In the case where the ECU 7L has the function of operating or stopping the engine 1 according to the condition of the vehicle, it may be determined that it is predicted that the engine 1 will be started when a condition for starting the engine 1 is satisfied. The predetermined time is set to be substantially the same as the time required to actually start combustion in the engine 1 after it is predicted that the engine 1 will be started.

When it is determined that the predetermined time has elapsed in step S21, the ECU 7L determines whether the engine 1 is being operated in step S22. In this case as well, the phrase “the engine 1 is being operated” signifies that the engine 1 is being operated by the combustion of fuel. In step S23, the ECU 7L determines whether the ECU 7R for the right bank 1R is normally operating, that is, whether the ECU 7R is normally performing the control function. When it is determined that the ECU 7R is normally operating, the ECU 7L determines whether the required fuel flow amount is in the large amount range in step S24. When it is determined that the required fuel flow amount is in the large amount range in step S24, the ECU 7L turns the second fuel pump 4 on so that the fuel is discharged from the second fuel pump 4 in step S25. When it is determined that the required fuel flow amount is not in the large amount range in step S24, the ECU 7L turns the second fuel pump 4 off, i.e., stops the second fuel pump 4 in step S26. By executing steps S23, S24, and S25 or S26, the above-described normal control of the second fuel pump 4 is executed.

When it is determined that a malfunction occurs in the ECU 7R for the right bank 1R in step S23, the ECU 7L skips S24, and proceeds to step S25. Thus, when a malfunction occurs in the ECU 7R, the second fuel pump 4 is turned on so that the fuel is supplied from the second fuel pump 4 to the engine 1, regardless of the required fuel flow amount. When a malfunction occurs in the ECU 7R, the first fuel pump 3 is unable to supply the fuel. If the normal control is executed in this situation, the second fuel pump 4 is turned off when the required fuel flow amount is in the small amount range and when the fuel flow amount is in the medium amount range. Therefore, no fuel is supplied to the engine 1 when the required fuel flow amount is in the small amount range and when the required fuel flow amount is in the medium amount range. In contrast, if the second fuel pump 4 is operated regardless of the required fuel flow amount after it is determined that a malfunction occurs in the ECU 7R in step S23, the fuel is supplied from the second fuel pump 4 to the engine 1, and the operation of the engine 1 can be continued when the required fuel flow amount is in the small amount range and when the required fuel flow amount is in the medium amount range. This reduces the possibility that a problem, such as misfire, occurs due to shortage of fuel supply.

When a negative determination is made in step S21, that is, when the predetermined time has not elapsed after it is predicted that the engine 1 will be started, the ECU 7L turns the second fuel pump 4 on in step S25, regardless of whether the engine 1 is being operated. Thus, the second fuel pump 4 is operated for the predetermined time before the engine 1 is started. During the normal control, the second fuel pump 4 is operated only when the required fuel flow amount is in the large amount range. In other words, the second fuel pump 4 is maintained in the stopped state when the required fuel flow amount is in the medium amount range, and when the required fuel flow amount is in the small amount range. Thus, the frequency of operating the second fuel pump 4 is lower than the frequency of operating the first fuel pump 3. If the second fuel pump 4 is maintained in the stopped state for a long time, the movable portion of the second fuel pump 4 may be fixed. However, by forcibly operating the second fuel pump 4 before the engine 1 is started as in this embodiment, it is possible to increase the frequency of operating the second fuel pump 4, thereby preventing the movable portion of the second fuel pump 4 from being fixed. Also, if the engine 1 is not started for a long period after the engine 1 is stopped, the pressure stored in the high-pressure pipes and the like for the engine 1 decreases. As a result, an appropriate fuel injection pressure may not be ensured at the start of the engine 1. The possibility that this problem occurs is also eliminated or reduced by forcibly operating the second fuel pump 4 and increasing the amount of fuel supplied to the engine 1 before the engine 1 is started. After the operation of the fuel pump 4 is controlled in step S25 or S26, the ECU 7L ends the present routine.

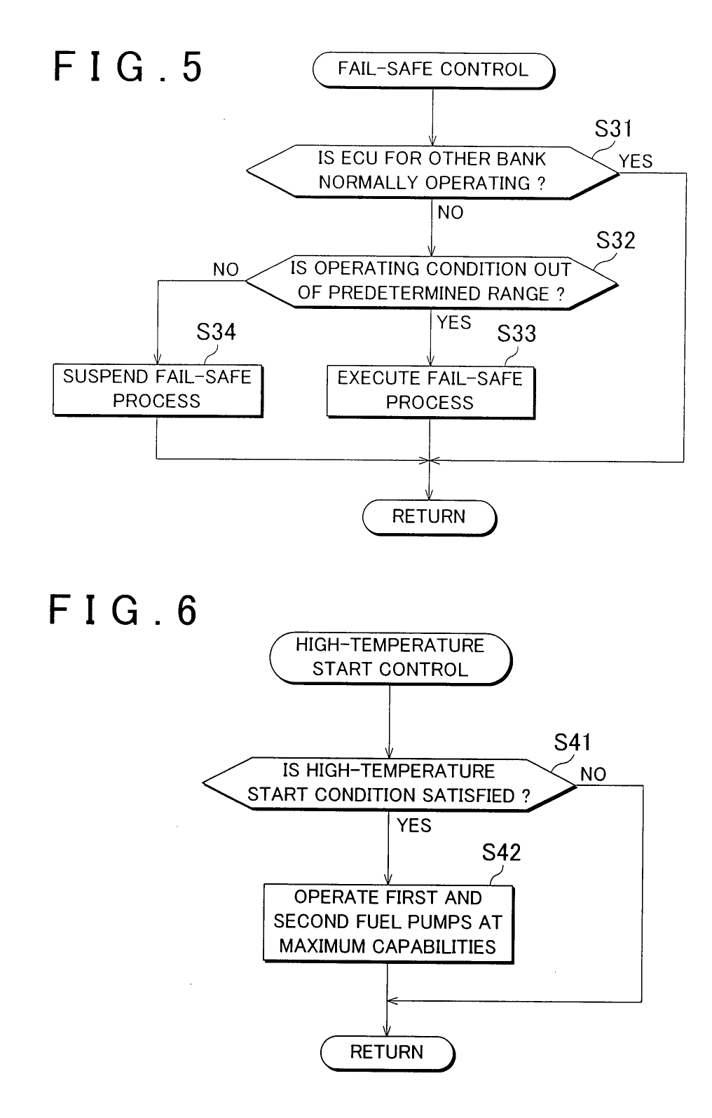

In each of the above-described pump control routines, when a malfunction occurs in the ECU 7L or 7R, the first fuel pump 3 or the second fuel pump 4, which belongs to the normal control system, is operated to continue the supply of fuel to the engine 1. However, if only one fuel pump is operated, a sufficient amount of fuel may not be supplied to the engine 1. For example, when the required fuel flow amount is in the large amount range, it is required to supply the fuel from both of the first and second fuel pumps 3 and 4. Therefore, if only one fuel pump is operated when the required fuel flow amount is in the large amount range, shortage of fuel occurs. Accordingly, each of the ECUs 7R and 7L repeatedly executes a fail-safe control routine shown in FIG. 5 at predetermined time intervals, in parallel with the pump control routine in FIG. 3 or FIG. 4. Thus, each of the ECUs 7R and 7L restricts the operating condition of the engine 1 in accordance with the amount of supplied fuel. This reduces the possibility that a problem, such as misfire, occurs due to shortage of fuel. Hereinafter, the control routine in FIG. 5 will be described. More specifically, hereinafter, the case where the ECU 7R for the right bank 1R executes the control routine in FIG. 5 will be described.

In the fail-safe control routine in FIG. 5, first, the ECU 7R determines whether the ECU for the bank that is not controlled by the ECU 7R (i.e., the ECU 7L for the left bank 1L in this case) is normally operating in step S31. When the ECU 7L is normally operating, the ECU 7R ends the present routine. Thus, the first and second fuel pumps 3 and 4 are operated according to the above-described normal control. When it is determined that the ECU 7L is not normally operating in step S31, the ECU 7R determines whether the operating condition of the engine 1 is out of a predetermined range in step S32. The predetermined range is set such that the required fuel flow amount is achieved by operating only the first fuel pump 3 when the operating condition of the engine 1 is in the predetermined range. As a value that indicates the operating condition, the ECU 7R refers to a physical amount such as the flow amount of fuel required for the engine 1 (i.e., the required fuel flow amount), or the speed of the engine 1 or an air-fuel ratio, which correlates with the required fuel flow amount. When the physical amount exceeds a value that corresponds to the maximum amount of fuel that can be supplied by the first fuel pump 3, it is determined that the operating condition is out of the predetermined range.

When it is determined that the operating condition is out of the predetermined range in step S32, the ECU 7R executes a predetermined fail-safe process in step S33. Then, the ECU 7R ends the present routine. The fail-safe process executed in step S33 restricts the operation of the engine 1 to reduce the flow amount of fuel required for the engine 1 (i.e., the required fuel flow amount) to a value that is equal to or below the maximum discharge amount of the fuel pump 3. For example, a fuel-supply cutoff control is executed as the fail-safe process. The fuel-supply cutoff control limits the amount of air taken into the engine 1 (i.e., the intake air amount), or prohibits fuel injection from the fuel injection valve. The intake air amount may be limited, for example, by limiting the opening amount of an electronically-controlled throttle valve, or the opening amount of an intake-air control valve disposed downstream of the throttle valve. Alternatively, the intake air amount may be limited by limiting the lift or duration of the intake valve of a variable valve mechanism. By executing the fail-safe process, it is possible to reduce the possibility that a problem, such as misfire, occurs due to shortage of fuel. When a malfunction occurs in the ECU 7L, the first fuel pump 3 is operated so that the fuel discharge amount is equal to the large discharge amount, according to the routine in FIG. 3. When a malfunction occurs in the ECU 7R, the second fuel pump 4 is operated according to the routine in FIG. 4. Therefore, it is possible to operate the engine 1 in the operating condition that is as closest as possible to the target operating condition, in accordance with the amount of fuel that can be supplied from only the first fuel pump 3 or only the second fuel pump 4. Also, it is possible to reduce the possibility that a problem, such as misfire, occurs due to shortage of fuel.

When it is determined that the operating condition is in the predetermined range in step S32, the ECU 7R suspends the fail-safe process in step S34, and then, the ECU 7R ends the present routine for the following reason. When it is determined that the operating condition is in the predetermined range, the engine 1 can be operated in the target operating condition, in accordance with the amount of fuel supplied from only the first fuel pump 3. Thus, the fail-safe process need not be executed.

The routine in FIG. 5 executed by the ECU 7R for the right bank 1R has been described. The routine in FIG. 5 executed by the ECU 7L for the left bank 1L is the same as the routine in FIG. 5 executed by the ECU 7R, except that the ECU 7L determines whether the ECU 7R for the right bank 1R is normally operating in step S31. However, because the maximum discharge amount of the first fuel pump 3 differs from the maximum discharge amount of the second fuel pump 4, the predetermined range set for step S32 in the case where the ECU 7R executes the routine in FIG. 5 differs from the predetermined range set for step S32 in the case where the ECU 7L executes the routine in FIG. 5. In the case where the ECU 7R executes the routine in FIG. 5, the predetermined range may be set such that the required fuel flow amount is in the medium to small amount ranges if the operating condition is in the predetermined range. In the case where the ECU 7L executes the routine in FIG. 5, the predetermined range may be set to be smaller than the predetermined range in the case where the ECU 7R executes the routine in FIG. 5. This is because the maximum discharge amount of the second fuel pump 4 is smaller than the maximum discharge amount of the first fuel pump 3.

In addition to the routines shown in FIG. 3 to FIG. 5, the ECUs 7R and 7L execute a high-temperature start control routine shown in FIG. 6. This routine is executed to increase the fuel pressure in the high-pressure pipes if the temperature of the engine 1 is high at the start of the engine 1. The time point at which the routine in FIG. 6 is started is set to the time point at which it is predicted that the engine 1 will be started. It may be determined whether it is predicted that the engine 1 will be started, in the same manner as in step S21 of the routine in FIG. 4. In first step S41 of the routine in FIG. 6, the ECUs 7R and 7L determine whether a high-temperature start condition is satisfied. The high-temperature start condition is set based on a physical amount, such as the temperature of engine coolant, the temperature of engine lubricating oil, the temperature of intake air, or the like, which correlates with the temperature of the engine 1. When the temperature of the engine 1 is equal to or above a predetermined value, it is determined that the high-temperature start condition is satisfied. When it is determined that the high-temperature start condition is not satisfied, the ECUs 7R and 7L end the high-temperature start control routine. In this case, the first and second fuel pumps 3 and 4 are controlled according to the routines in FIG. 3 and FIG. 4, respectively. When it is determined that the high-temperature start condition is satisfied, the ECU 7R and the ECU 7L operate the first and second fuel pump 3 and 4 at their maximum capabilities, respectively in step S42. That is, the ECU 7R operates the first fuel pump 3 so that the fuel discharge amount is equal to the large discharge amount, and the ECU 7L turns the second fuel pump 4 on, i.e., operates the second fuel pump 4. After the first and second fuel pumps 3 and 4 are operated in step S42, the routine ends.

According to the high-temperature start control routine in FIG. 6, if the temperature of the engine 1 is high at the start of the engine 1, the first and second fuel pumps 3 and 4 are operated at their maximum capabilities. This increases the fuel pressure in the shortest possible time. Thus, it is possible to reduce the possibility that a problem, such as vapor lock, occurs due to an increase in the temperature of the fuel, and to reliably start the engine 1 when the temperature of the engine 1 is high.

In the above-described embodiment, the control device 6 may function as the fuel pump control apparatus. The combination of the ECUs 7R and 7L may function as the first pump control means. When a negative determination is made in step S21 of the routine in FIG. 4, and then step S25 is executed, the ECU 7L may function as the second pump control means. When an affirmative determination is made in step S41 of the routine in FIG. 6, and then step S42 is executed, both of the ECUs 7R and 7L may function as the second pump control means.

The invention is not limited to the above-described embodiment. That is, the invention may be realized in various embodiments. For example, although the ECUs 7R and 7L are provided for the right and left banks, respectively in the invention, the ECUs 7R and 7L may be integrated into one single ECU, and the ECU may function as the first pump control means and the second pump control means. The first pump control means and the second pump control means may belong to different control units.

In the above-described embodiment, when it is predicted that the internal combustion engine will be started, the second fuel pump is operated for the predetermined time. However, the timing for operating the second fuel pump is not limited to this timing. For example, when the internal combustion engine is idling, the second pump control means may temporarily operate the second fuel pump. Alternatively, when fuel supply is cut off, or the internal combustion engine is operated with a reduced number of cylinders during deceleration, the second fuel pump control means may operate the second fuel pump. If the second fuel pump is operated when the internal combustion engine is in a stable condition, for example, when the internal combustion engine is stopped or idling, there is an advantage of reducing the the possibility that the operating condition of the internal combustion engine is influenced by the increase in the fuel pressure in the high-pressure fuel system, which is caused by the operation of the second fuel pump. If the second fuel pump is operated when the internal combustion engine is stopped, there is no possibility that the operating condition of the internal combustion engine is changed. If the second fuel pump is operated when the internal combustion engine is idling, the operating condition of the internal combustion engine is not much influenced. Further, although the second fuel pump is operated for the predetermined time each time it is predicted that the internal combustion engine will be started in the above-described embodiment, the second pump control means may be permitted to operate the second fuel pump only when a predetermined condition is satisfied, for example, only when the number of times that the second fuel pump is stopped exceeds a given number, or only when the period during which the second fuel pump is stopped exceeds a given period. In this case, when the predetermined condition is not satisfied, the second pump control means is prohibited from operating the second fuel pump.

In the above-described embodiment, when a negative determination is made in step S21 of the routine in FIG. 4, the second fuel pump is operated to increase the fuel injection pressure at the start of the internal combustion engine. However, as long as the fuel injection pressure is increased at the start of the internal combustion engine, the first fuel pump may be operated instead of, or in addition to the second fuel pump, before the internal combustion engine is started. The fuel pump control apparatus according to the invention may be employed not only for a V-engine, but also for various types of internal combustion engines.

In the above-described embodiment, when the ECUs 7R and 7L execute step S12 of the routine in FIG. 3, and step S23 of the routine in FIG. 4, respectively, the ECUs 7R and 7L function as the malfunction detection means. When a negative determination is made in step S12 of the routine in FIG. 3, and accordingly step S14 is executed, the ECU 7R functions as the pump operation means. When a negative determination is made in step S23 of the routine in FIG. 4, and accordingly step S25 is executed, the ECU 7L functions as the pump operation means. When step S33 of the routine in FIG. 5 is executed, the ECUs 7R and 7L function as the operation restriction means.

The invention is not limited to the above-described embodiment. That is, the invention may be realized in various embodiments. For example, in the above-described embodiment, it is determined whether a malfunction occurs in each of the control systems by determining whether a malfunction occurs in the ECU 7L in step S12 of the routine in FIG. 3, and determining whether a malfunction occurs in the ECU 7R in step S23 of the routine in FIG. 4. However, the malfunction determination means is not limited to this. The malfunction determination means may be appropriately modified as long as the malfunction determination means determines whether a malfunction occurs in the fuel supply function of each control system. For example, the malfunction determination means may monitor whether each of the first and second fuel pumps 3 and 4 is normally operating. In this case, if the first fuel pump 3 or the second fuel pump 4 is not normally operating, the malfunction determination means may determine that a malfunction occurs in the control system to which the malfunctioning fuel pump belongs. That is, in this invention, the phrase “a malfunction occurs in the fuel supply function” signifies the case where a malfunction occurs in the control function of the control unit, or the case where a malfunction occurs in the fuel pump.

The number of the fuel pumps is not limited to two, and the number of the control units is not limited to two. The number of the fuel pumps, and the number of the control units may be two or more. The invention is not limited to the configuration in which the control units correspond one-to-one with the fuel pumps. The correspondence relation between the control units and the fuel pumps may be appropriately set, as long as the control units control a plurality of fuel pumps that are divided into a plurality of control systems. The control apparatus according to the invention may be employed not only for a V-engine, but also for various types of internal combustion engines.

While the invention has been described with reference to exemplary embodiments thereof, it is to be understood that the invention is not limited to the exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element, are also within the spirit and scope of the invention.

What is claimed is:

1. A fuel pump control apparatus for an internal combustion engine, comprising:
a plurality of fuel pumps that discharge fuel so that the discharged fuel is supplied to the internal combustion engine; and
a controller that determines whether to supply the fuel discharged from one of the plurality of fuel pumps to the internal combustion engine, or to supply all the fuel discharged from the plurality of fuel pumps together to the internal combustion engine, based on an operating condition of the internal combustion engine.

2. The fuel pump control apparatus according to claim 1, wherein
the controller includes:
a first pump controller that operates each of the plurality of fuel pumps based on an amount of fuel required for the internal combustion engine so that frequency of operating at least one of the plurality of fuel pumps is lower than frequency of operating a rest of the plurality of fuel pumps; and
a second pump controller that operates the at least one of the plurality of fuel pumps when a predetermined condition for the first pump controller to stop the at least one of the plurality of fuel pumps is satisfied.

3. The fuel pump control apparatus according to claim 2, wherein
the plurality of fuel pumps include a first fuel pump, and a second fuel pump whose maximum discharge amount is smaller than a maximum discharge amount of the first fuel pump; and
the first pump controller controls each of the first pump and the second pump so that frequency of operating the second fuel pump is lower than frequency of operating the first fuel pump, by operating the first fuel pump and the second fuel pump when the amount of fuel required for the internal combustion engine is equal to or above a predetermined value, and by stopping the second fuel pump when the amount of fuel required for the internal combustion engine is below the predetermined value.

4. The fuel pump control apparatus according to claim 3, wherein
the second pump controller operates the second fuel pump when the internal combustion engine is in a stable condition.

5. The fuel pump control apparatus according to claim 4, wherein
when the internal combustion engine is stopped, or when the internal combustion engine is idling, the second pump controller determines that the internal combustion engine is in the stable condition, and operates the second fuel pump.

6. The fuel pump control apparatus according to claim 3, wherein
when it is predicted that the internal combustion engine will be started, the second pump controller operates the second fuel pump.

7. The fuel pump control apparatus according to claim 6, wherein
when an ignition switch for starting the internal combustion engine is turned on, the second pump controller determines that it is predicted that the internal combustion engine will be started, and operates the second fuel pump.

8. The fuel pump control apparatus according to claim 6, wherein
the internal combustion engine is used as a power source for driving a vehicle; and
when it is determined that an occupant climbs into a driver's seat, the second pump controller determines that it is predicted that the internal combustion engine will be started, and operates the second fuel pump.

9. The fuel pump control apparatus according to claim 6, wherein
when it is predicted that the internal combustion engine will be started, and a temperature of the internal combustion engine is in a predetermined high-temperature range, the second pump controller operates both of the first fuel pump and the second fuel pump.

10. The fuel pump control apparatus according to claim 1, wherein
the controller further includes a plurality of control units which are divided into a plurality of control systems, and which control the plurality of fuel pumps that are divided into the plurality of control systems; and
each of the plurality of control units includes
a malfunction determination device that determines whether a malfunction occurs in a fuel supply function of each of the plurality of control systems excluding a control system to which the malfunction determination device belongs, and
a pump operation device that operates at least one of the plurality of fuel pumps, which belongs to the control system to which the pump operation device belongs, to continue an operation of the internal combustion engine, when the malfunction determination device determines that a malfunction occurs in the fuel supply function of at least one of the plurality of control systems.

11. The fuel pump control apparatus according to claim 10, wherein
when the malfunction determination device determines that a malfunction occurs, the pump operation device operates the at least one of the plurality of fuel pumps, which belongs to the control system to which the pump operation device belongs so that an amount of fuel discharged from the at least one of the plurality of fuel pumps is equal to a maximum discharge amount, regardless of an operating condition of the internal combustion engine.

12. The fuel pump control apparatus according to claim 10, wherein
each of the control units further includes an operation restriction device that restricts an operating condition of the internal combustion engine to a predetermined range set based on an amount of fuel that can be supplied from the at least one of the plurality of fuel pumps, which is operated by the pump operation device, when the malfunction determination device determines that a malfunction occurs.

13. The fuel pump control apparatus according to claim 12, wherein
the operation restriction device restricts the operating condition of the internal combustion engine to the predetermined range by limiting an amount of air taken into the internal combustion engine.

14. The fuel pump control apparatus according to claim 12, wherein
the operation restriction device restricts the operating condition of the internal combustion engine to the predetermined range by prohibiting fuel injection from a fuel injection valve of the internal combustion engine.

15. The fuel pump control apparatus according to claim 10, wherein
when the malfunction determination device of each of the plurality of control units determines that no malfunction occurs, each of the plurality of control units changes amounts of fuel discharged from each of the plurality of fuel pumps which belongs to the control system, based on an amount of fuel required for the internal combustion engine.

16. The fuel pump control apparatus according to claim 15, wherein
when the malfunction determination device of each of the plurality of control units determines that no malfunction occurs, the plurality of control units stop at least one of the plurality of fuel pumps when the amount of fuel required for the internal combustion engine is small, and operate all the plurality of fuel pumps when the amount of fuel required for the internal combustion engine is large.

17. The fuel pump control apparatus according to claim 16, wherein
a maximum discharge amount of the at least one of the plurality of fuel pumps is smaller than a maximum discharge amount of a rest of the plurality of fuel pumps; and
when the malfunction determination device of each of the plurality of control units determines that no malfunction occurs, and the amount of fuel required for the internal combustion engine is small, the plurality of control units stop the at least one of the plurality of fuel pumps, whose maximum discharge amount is smaller than the maximum discharge amount of the rest of the plurality of fuel pumps.

18. The fuel pump control apparatus according to claim 10, wherein
the plurality fuel pumps include a first fuel pump, and a second fuel pump whose maximum discharge amount is smaller than a maximum discharge amount of the first fuel pump; and
the plurality of control units include a first control unit that controls the first fuel pump, and a second control unit that controls the second fuel pump.
